(19) United States
(12) Patent Application Publication
(10) Pub. No.: US 2016/0112759 A1
(43) Pub. Date: Apr. 21, 2016

(54) SCHEMA FOR INTERESTS AND DEMOGRAPHICS PROFILE FOR ADVANCED BROADCAST SERVICES

(71) Applicant: SONY CORPORATION, Tokyo (JP)

(72) Inventors: Mark EYER, Park Ridge, NJ (US); Yasuaki YAMAGISHI, Kanagawa (JP)

(73) Assignee: SONY CORPORATION, Tokyo (JP)

(21) Appl. No.: 14/985,167

(22) Filed: Dec. 30, 2015

Related U.S. Application Data
(63) Continuation of application No. 13/009,720, filed on Jan. 19, 2011.

(51) Int. Cl. H04N 21/458; H04N 21/443; H04N 21/466; H04N 21/475; H04N 21/45

(52) U.S. Cl. CPC H04N 21/458; H04N 21/4755; H04N 21/4532; H04N 21/4667; H04N 21/4431

(57) ABSTRACT

According to one embodiment, a computer-implemented method for a digital broadcast system comprises an operation of receiving and processing an electronic questionnaire from at least one service provider of the digital broadcast system by a receiver. For instance, the electronic questionnaire has a first data structure that, when processed by the receiver, generates for display a plurality of questions. Thereafter, the method comprises an operation of acquiring answers to the electronic questionnaire in the receiver. The answers are used in filtering content subsequently downloaded to the receiver.

### TECHNICAL FIELD

Embodiments of the present invention relate to the field of communications, in particular metadata pertinent to advanced broadcast services.

### BACKGROUND

Traditional media distribution systems such as broadcasting lack the ability to characterize and respond to consumer preferences in order to provide customized media content. For example, such customized media content may include targeted advertising or marketing material of specific interest to the particular viewer.

Furthermore, viewers may not be interested in some media content. For example, a particular advertisement for local services may be suitable for viewers living in the geographic area served by the advertiser and not suitable for viewers living in a different area. Another example is that some viewers may be more interested in certain topic or genre areas such as sports broadcasting while others prefer programs of a different type, such as cooking or gardening shows.

Currently, there are no standardized methods to specify how a viewer might customize their viewing preferences with respect to the content and services they receive. Existing systems may typically filter out program content based on viewer preference settings established in the receiver by the manufacturer of that receiver, with no input from the service provider as to the types of filtering criteria that might be suitable for the particular service. Furthermore, service providers do not have access to the viewer preference settings and thus are not able to directly tailor the user's experience of the service based on those settings.

### BRIEF DESCRIPTION OF THE DRAWINGS

Embodiments of the present invention are illustrated by way of example, and not by way of limitation, in the figures of the accompanying drawings and in which:

FIG. 1 is a block diagram illustrating one embodiment of a digital broadcasting system.

FIG. 2 is a block diagram illustrating one embodiment of a receiver.

FIG. 3A is a block diagram illustrating one embodiment of a receiver receiving triggered declarative objects (TDOs).

FIG. 3B is a block diagram illustrating one embodiment of a receiver receiving non-real time (NRT) triggered declarative objects (TDOs).

FIG. 4 is a block diagram illustrating one embodiment of a receiver receiving non-real time (NRT) content.

FIG. 5 is a block diagram illustrating one embodiment of a system for storing and manipulating a PDI questionnaire in a receiver.

FIG. 6 is a flow diagram illustrating one embodiment of a system for filtering content based on answers to a PDI questionnaire in a receiver.

FIG. 7 is a flow diagram illustrating one embodiment of a method for downloading selected content at a receiver.

FIG. 8 is a flow diagram illustrating one embodiment of a method for executing a triggered declarative object (TDO) script based on answers to a PDI questionnaire in a receiver.

FIGS. 9A and 9B are flow diagrams generally illustrating one embodiment of a system and method for registration as well as receiving a PDI questionnaire and manipulating answers to the PDI questionnaire at a receiver.

FIG. 10 is a diagram illustrating one embodiment of a data structure of PDI questions.

FIG. 11 is a diagram illustrating one embodiment of a data structure of PDI answers.

FIG. 12 is a block diagram illustrating one embodiment of a PDI structure.

FIG. 13 is a block diagram illustrating one embodiment of a table schema of a PDI container.

### DETAILED DESCRIPTION

Embodiments of the invention relate to a digital broadcast receiver described herein. According to one embodiment of the invention, the digital broadcast receiver comprises a storage device and processing logic. The storage device is configured to store a questionnaire received from at least one service provider of a digital broadcast system, and answers to the questionnaire. The processing logic is configured to process data received from the at least one service provider based on answers to the questionnaire. The questionnaire and answers are stored in a table format. An Extensible Markup Language (XML) schema of the table has a first set of questions and answers common to all service providers and may have a second set of questions and answers specific to least one service provider.

Herein, certain terminology is used to describe features of the invention. For example, the term “logic” is generally defined as hardware and/or software. As hardware, logic may include processing circuitry (e.g., a microprocessor, a programmable gate array, a controller, an application specific integrated circuit, etc.), semiconductor memory, combinatorial logic, or the like. As software, the logic may be one or more software modules, such as executable code in the form of an application, an application programming interface (API), an applet, a routine, or one or more instructions. Software modules may be stored in any type of storage device, a suitable storage medium such as a programmable electronic circuit, a semiconductor memory including a volatile memory (e.g., random access memory, etc.), any type of non-volatile memory (e.g., read-only memory, flash memory, a hard drive, etc.), a portable memory device (e.g., an optical disk, a Universal Serial Bus “USB” flash drive), or the like.

The term “data structure” represents syntax/semantics. For instance, an XML Schema is a data structure because it specifies the allowed formals of the “instances”—objects in the specified format that carry information.

An “electronic device” generally represents electronics with information processing capabilities such as a television receiver for example. As optional features, electronic device may include a display (e.g., liquid crystal diode (“LCD”), organic LCD (OLCD), plasma, etc.) and speakers to support video/audio playback. An “interconnect” is generally defined as a communication pathway established over an information-carrying medium. This information-carrying medium may be a physical medium (e.g., electrical wire, optical fiber, cable, bus traces, etc.), a wireless medium (e.g., air in combination with wireless signaling technology) or a combination thereof.

A “service provider” generally represents a source and/or distributor of content. Examples of a service provider may include, but are not limited or restricted to a television network operator (e.g. local network television station, affiliate, cable television provider, telco, terrestrial, satellite TV provider, Internet service provider, etc.), an entity supplying access to stored content (e.g., Netflix®, etc.), or the like.

[0025]Certain details are set forth below in order to provide a thorough understanding of various embodiments of the invention, albeit the invention may be practiced through many embodiments other that those illustrated. Well-known logic and operations are not set forth in detail in order to avoid unnecessarily obscuring this description.

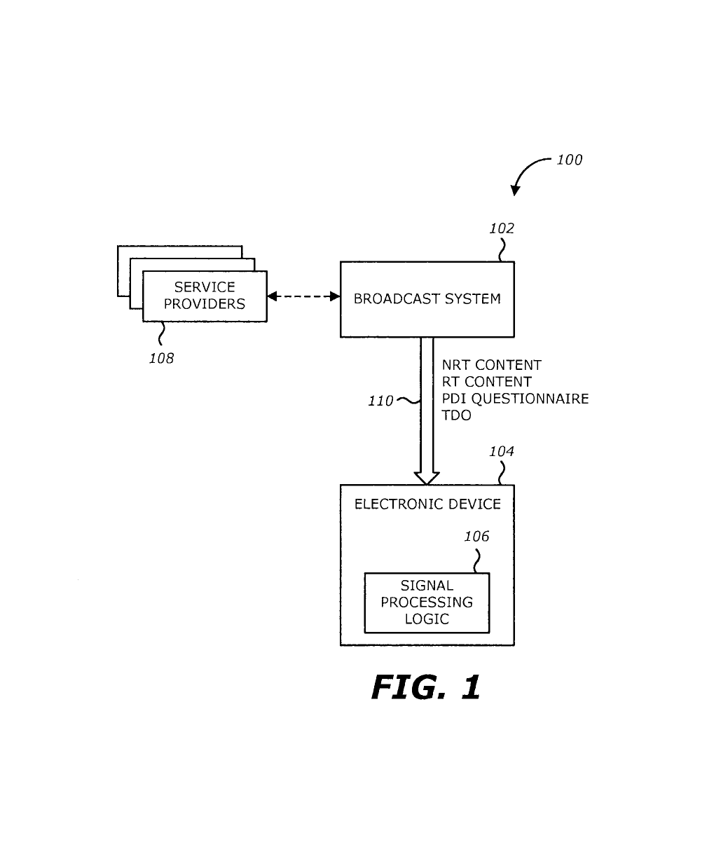

FIG. 1 is a block diagram illustrating one embodiment of a digital television service system 100. A broadcast system 102 receives content from service providers 108, and thereafter, transmits such content to an electronic device 104 over interconnect 110.

In one embodiment, the transmitted content includes one or more of the following: non-real-time (NRT) content, real-time or linear content, metadata associated with content, a questionnaire, and triggered declarative objects (TDOs).

NRT content includes content that is delivered faster or slower than real-time. In one embodiment of the invention, this content is audio/video data, although the content may be other forms of information. For instance, the content can be audio-only or web pages that can be displayed by a web browser. Alternatively or in combination with another content type, the content may include descriptions of available NRT content. These descriptions enable a user to select from a list of NRT content for later download. The user can also navigate and select from among previously downloaded content which to view.

Herein, advanced services associated with NRT content may be request-based or automatic where the receiver updates content associated with a service. For automatic-based services, the receiver caches service-related content and automatically updates files as new versions are made available. For request-based “push” service, content that has been preloaded is displayed.

Metadata associated with content describes the available content and services.

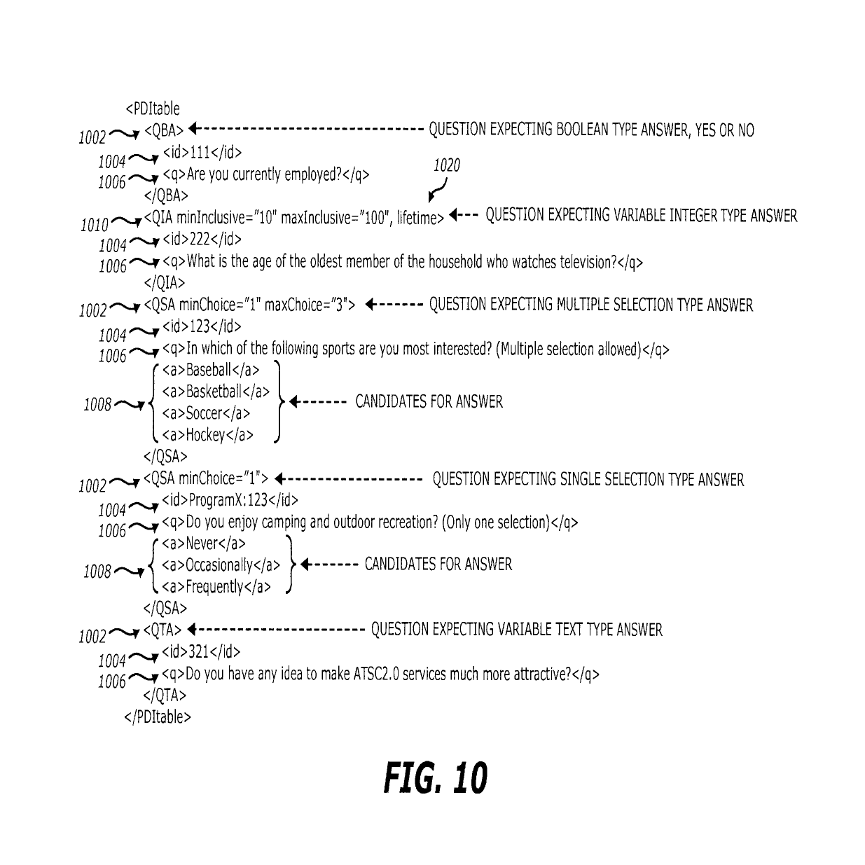

A questionnaire can allow users to specify various items of information about themselves that can allow the receiver to tailor advanced services based on the users' individual interests and preferences. In one embodiment of the invention, the questionnaire includes a data structure having a standardized format of preferences, demographics, and/or interests (PDIs) common to one or more service providers. For example, the format of the questionnaire would consist of questions, each with an answer in a predefined format. Possible answer formats could include yes/no or true/false, text string (with maximum length), multiple choice, integer (with range limits), checklist, among others. FIG. 10 illustrates an example of a format and data structure of an example PDI questionnaire.

TDOs are downloadable objects created by a content creator or service provider. In one embodiment, TDOs consist of declarative content (e.g., scripts, text, and graphics) whose function and behavior are tied in some way to the television programming they accompany. For example, a TDO may be designed to collect viewer response data such as voting on a game show or contest.

In one embodiment of the invention, electronic device 104 may be included in a set-top box or as part of a display device such as a display panel (e.g. television). Electronic device 104 includes signal processing logic 106 configured to process content received from broadcast system 102 as further described below. In one embodiment, signal processing logic 106 includes a processor capable of handling services broadcast according to Advanced Television Systems Committee (ATSC) standards.

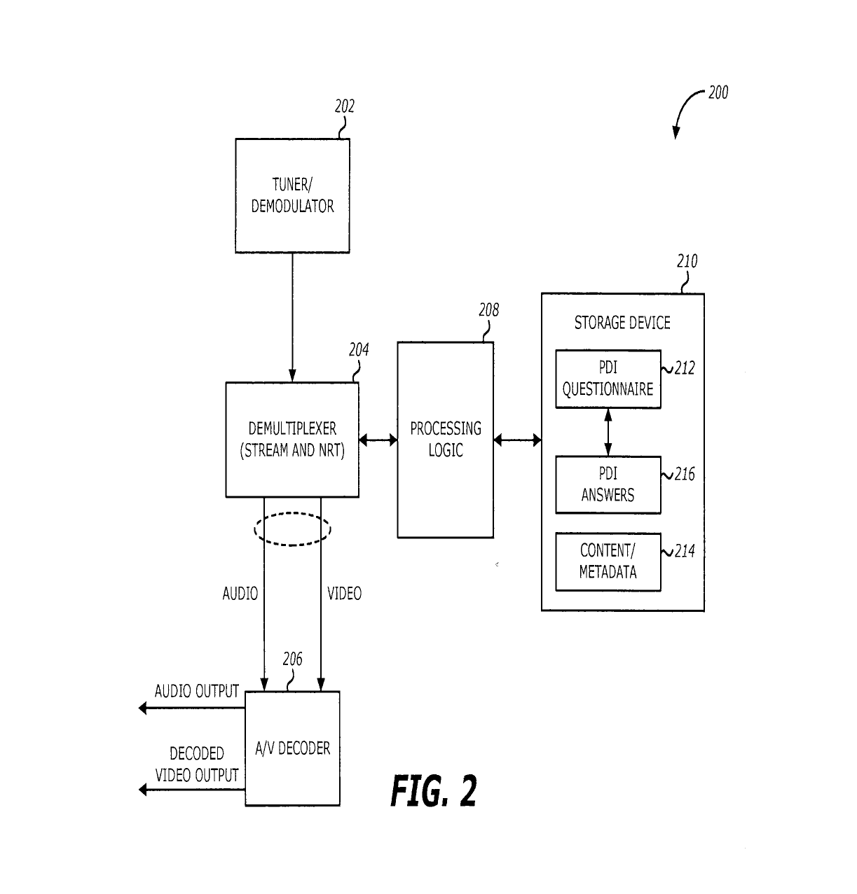

FIG. 2 is a block diagram illustrating one embodiment of a digital broadcast receiver 200 designed to receive both real-time television broadcasts and NRT content. Receiver 200 includes a tuner/demodulator 202, a demultiplexer 204, an audio/video decoder 206, processing logic 208, and a storage device 210,

Tuner 202 receives a modulated input signal, tunes and demodulates the signal to produce an output transport stream. Demultiplexer 204 demultiplexes the stream to produce data to processing logic 208. In the case of conventional real-time (linear) TV content, audio and video packets from tuner/demodulator 202 are supplied, via demultiplexer 204, to A/V decoder 206 for decoding. A/V decoder 206 supplies an audio output signal and a video output signal to a TV's audio and video circuit (not shown).

Content including audio/video, PDI questionnaires, NRT files, metadata, and TDOs received at demultiplexer 204 is routed via processing logic 208 to storage device 210. According to one embodiment of the invention, storage device 210 stores PDI questionnaire 212, answers to PDI questionnaire 216, and content and metadata 214. Herein, PDI questionnaire 212 is a downloadable questionnaire generated by at least one service provider having a standardized data structure.

Storage device 210 may include a disc drive, a non-volatile memory, or any other types of data storage device. When a user instructs the system to play a selected item of NRT content, that content is then processed by processing logic 208 and demultiplexed by demultiplexer 204 to provide audio and video packets to A/V decoder 206 to be eventually presented to the user.

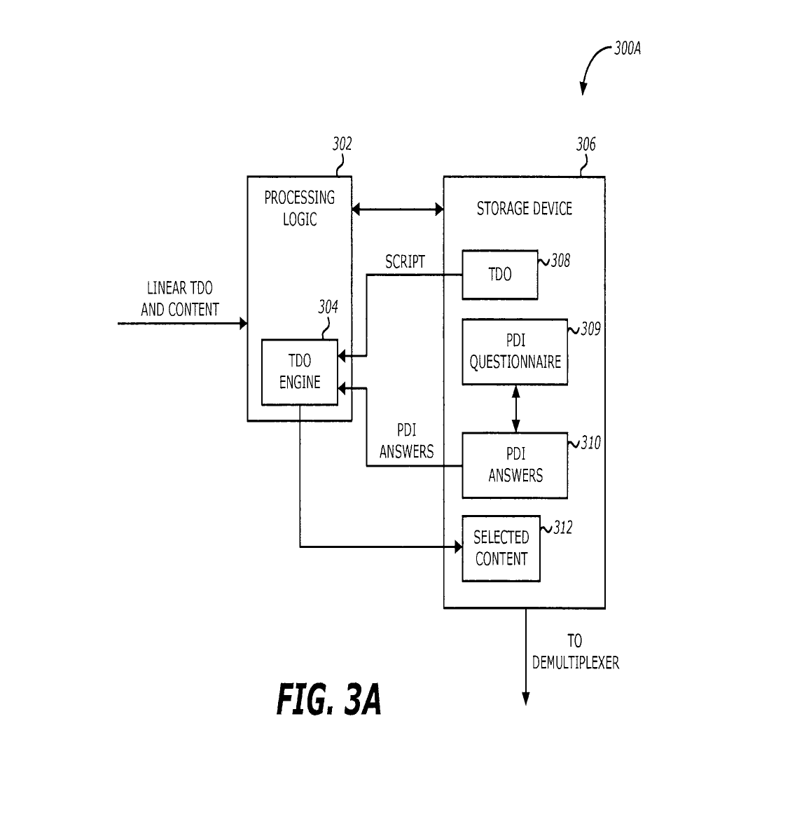

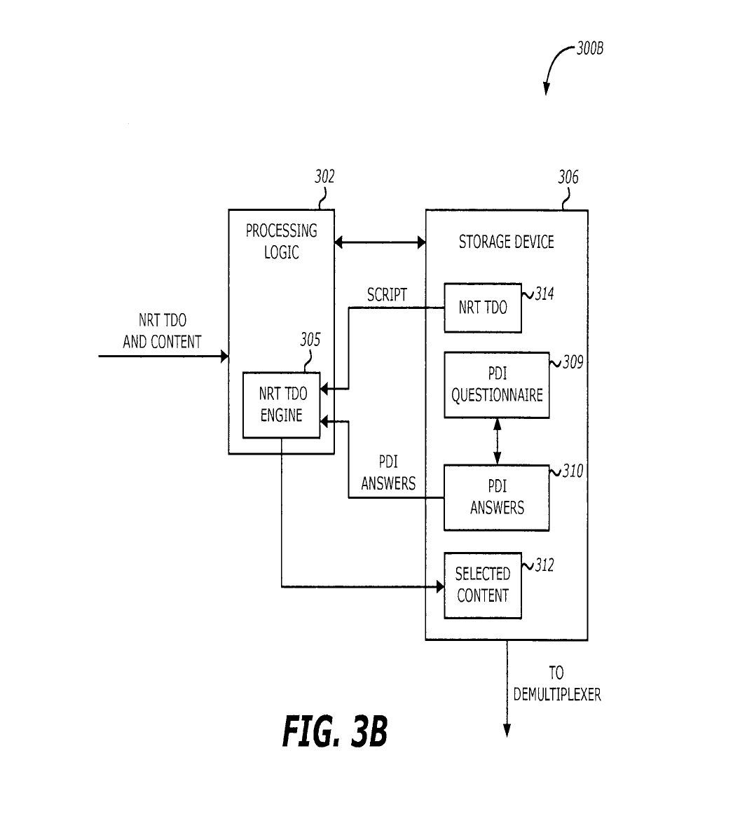

FIG. 3A is a block diagram illustrating one embodiment of a receiver 300A receiving triggered declarative objects (TDOs). As previously discussed, TDOs are downloadable objects configured to interact with a user to enhance his/her viewing experience. A user may be notified that an enhanced (interactive) experience is being offered and accompanies a given program.

For instance, according to one illustrative example, a user viewing a financial network program may be offered by a Stock Portfolio TDO to view his/her personalized stock when metadata associated with the financial network program indicates that screen space is available. The user may initialize the Stock Portfolio TDO with a list of stocks of interest.

In another example, a Favorite Driver Watch TDO is offered to a viewer watching a televised car race. The Favorite Driver Watch TDO enhances the viewer experience by displaying a thumbnail photo of the driver, his current speed, revolutions per minute (RPM), and position in the race. The Favorite Driver Watch TDO disappears from view during advertising spots and whenever racing is suspended or complete.

In yet another example, a Voting TDO can be used to capture viewer input while watching a talent contest. The Voting TDO is activated to allow a viewer to vote on a singer's performance.

TDO 308 (e.g., scripts and associated data such as graphics, text, audio files, HTML, etc.) may be stored in storage device 306. Processing logic 302 executes an operation of the TDO 308 with a TDO engine 304. For example, processing logic 302 executes a script of Stock Portfolio TDO to display a list of stocks of interests to a viewer when the viewer is watching a financial program on a network with metadata indicating available screen space.

Storage device 306 also includes PDI questionnaire 309 and PDI answers 310. PDI answers 310 contain answers to the questions in PDI questionnaire 309. The PDI questionnaire and answers may be in a standardized data structure format common to various service providers.

According to one embodiment of the invention, TDO 308 access PDI answers 310 through an Application Programming Interface (API) and exhibits actions and behaviors conditionally based on responses recorded in PDI answers 310. A script in TDO 308 could, for example, create one user experience if the age of the oldest TV-watching member of the household is 35 or less and a different experience otherwise. Different user experiences can include display of different text or graphics, branching to different audio/video content, and including different choices in a list.

In another embodiment of the invention, selected content 312 from the TDO 308 in response to the answers of PDI answers 310 may be stored within storage device 306.

FIG. 3B is a block diagram illustrating one embodiment of a receiver 300B receiving non-real time (NRT) triggered declarative objects (TDOs). Similarly, processing logic 302 executes a script from NRT TDO 314 with a NRT TDO engine 305. For example, NRT TDO 314 includes all the functionality of a regular TDO 308 and in addition may include references to NRT content and hyperlinks that, if taken, cause receiver 300B to set up a future download of an NRT content item, and/or hyperlinks that allow playback of previously downloaded content.

In one embodiment, the script in NRT TDO 314 accesses PDI questionnaire 309 and PDI answers 310 through an Application Programming Interface (API) and behaves based on PDI answers 310. For example, a script in a NRT TDO 314 could offer the viewer the choice to select and purchase a baseball game program for a particular team based the user's favorite team as specified in PDI answers 310.

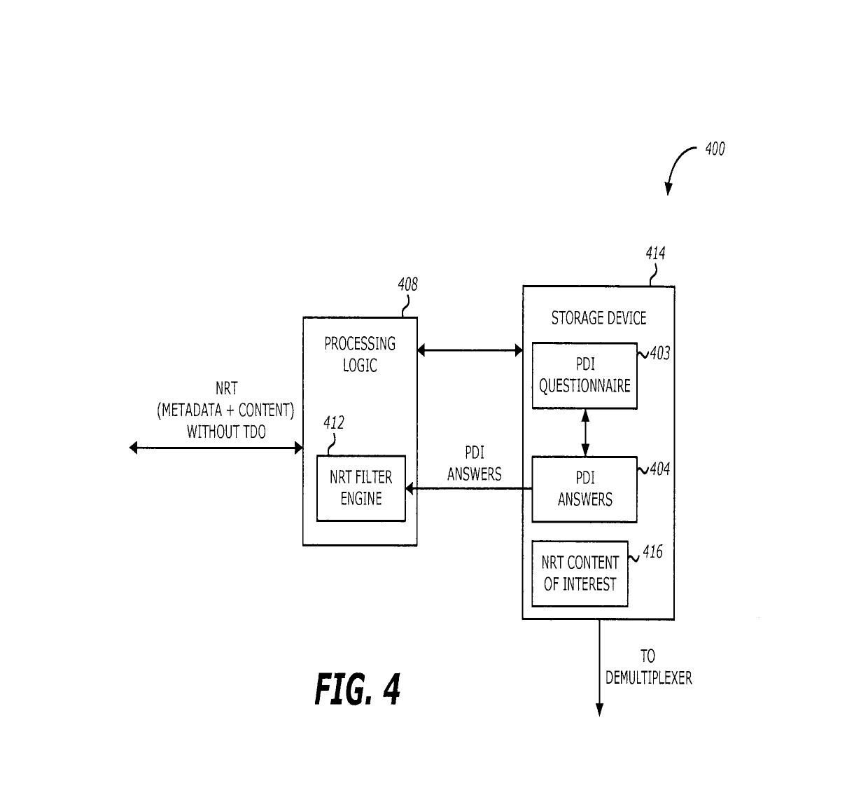

FIG. 4 is a block diagram illustrating one embodiment of a receiver 400 receiving non-real time (NRT) content. Processing logic 408 filters content without use of TDOs according to PDI answers 404 to PDI questionnaire 403 with content filter/matching engine 412. For example, processing logic 408 matches a local advertisement based on a geographic region of the viewer as specified in his/her PDI answers 404. Metadata received at the processing logic 408 is tied to PDI questionnaire 403 by the ID value of the question in the questionnaire. As such, in the previous example, filter engine 412 is able to know which PDI answer relates to the geographic location question.

In one embodiment, processing logic 408 filters and stores NRT content of interest 416 based on the interest of the viewer. For example, movie previews or trailers matching the preference (e.g., action, drama, comedy, etc. . . . ) of the viewer as set forth in PDI answers 404 are stored in storage device 414.

In another embodiment, processing logic 408 filters and stores received NRT content using metadata associated with the NRT content.

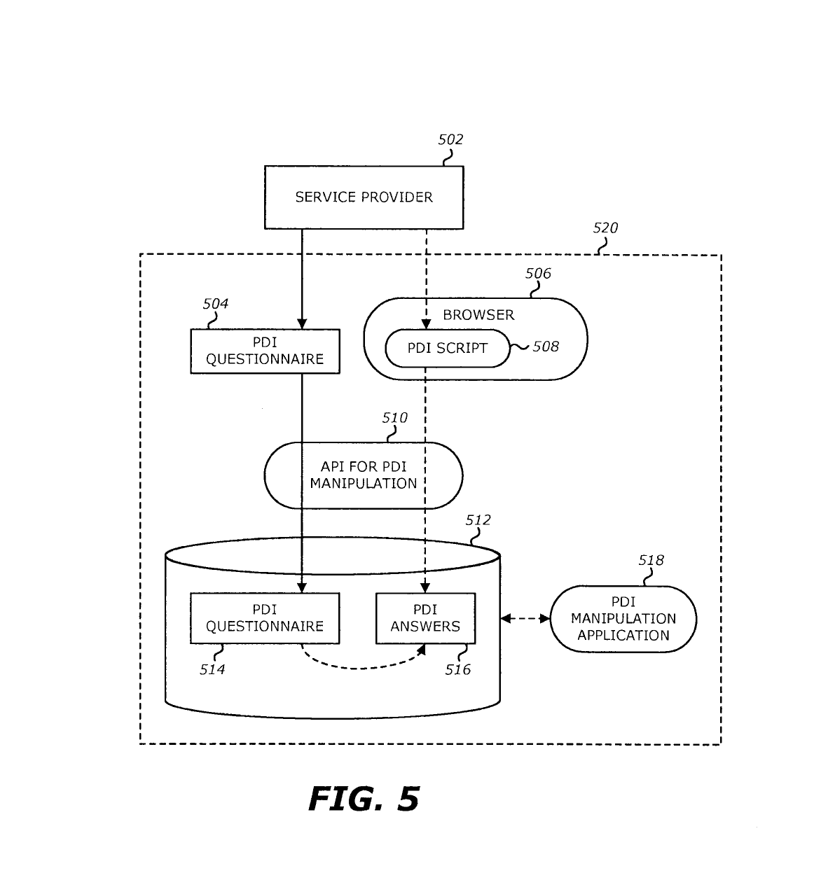

FIG. 5 is a block diagram illustrating one embodiment of a system for storing and manipulating PDI questionnaires in a receiver. A service provider 502 generates a PDI questionnaire 504 that is transmitted to a receiver 520. An API for PDI manipulation 510 allows for receiver 520 to store the PDI questionnaire 504 in storage device 512. A user/viewer is able to generate, update, and delete PDI answers 516 to PDI questionnaire 514 via PDI manipulation application 518. In one example, PDI manipulation application 518 takes the form of a set up screen on a display device coupled to receiver 520.

In another embodiment, a web browser 506 of receiver 520 includes a PDI script 508 configured to write and generate PDI answers 516 to the PDI questionnaire 504.

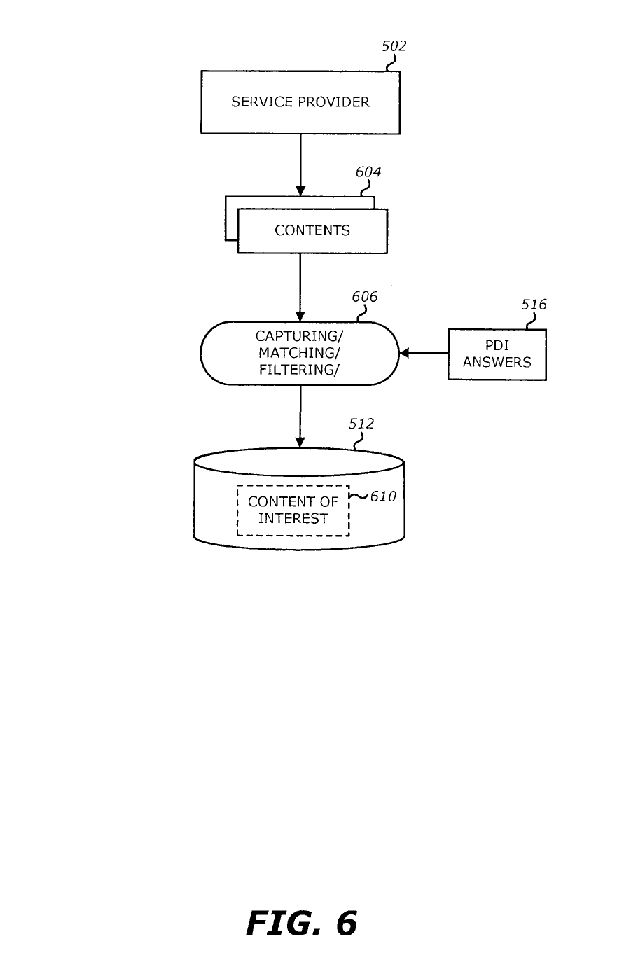

FIG. 6 is a block diagram illustrating one embodiment of a system for filtering content based on answers to a PDI questionnaire in a receiver. Service provider 502 distributes contents 604. Receiver 606 captures, matches, or filters contents 604 based on PDI answers 516. Content of interest 610 (e.g. content that matches the preferences of the viewer as specified in PDI answers 516) can be stored in storage device 512.

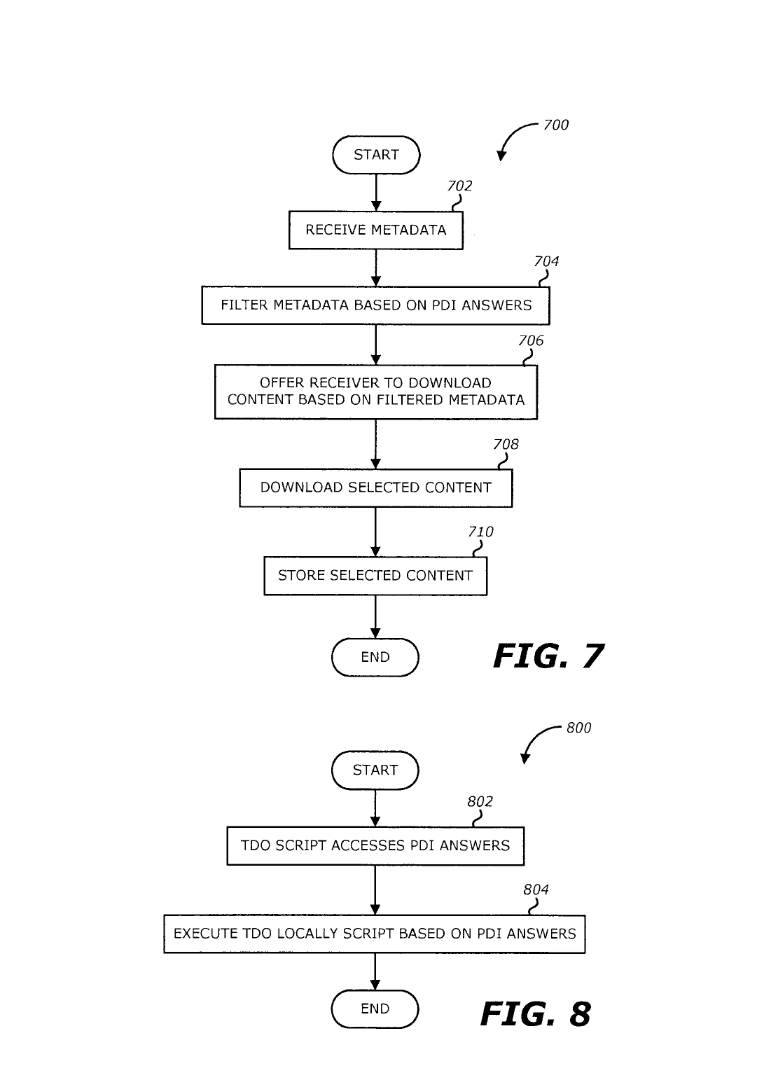

FIG. 7 is a flow diagram 700 illustrating one embodiment of a method for downloading selected content at a receiver. At 702, a receiver receives metadata descriptive of an associated content item. At 704, the receiver filters metadata based on PDI answers. At 706, the receiver offers the viewer the option to download content based on the matched PDI answers. For example, the receiver can filter or prioritize NRT content based on PDI responses. At 708, the viewer selects and downloads the selected content. In another embodiment, the selected content may be set to be downloaded at a future time (e.g. overnight). At 710, the selected content is stored in a storage device of the receiver.

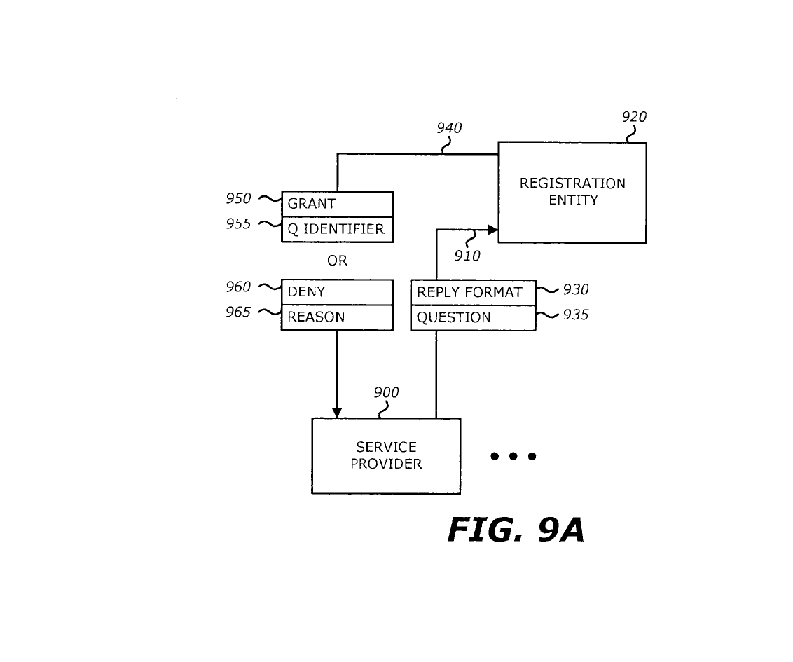

FIG. 8 is a flow diagram 800 illustrating one embodiment of a method for executing scripts in triggered declarative objects (TDOs) based on answers to a PDI questionnaire in a receiver. At 802, a TDO accesses PDI answers via an API. At 804, the processing logic of the receiver executes the TDO script, which contains conditional branching or other logic to alter its behavior based on the PDI answers (e.g. displaying the telephone number of a local merchant on the screen).

Once downloaded and executed, TDOs access metadata and triggers to support their expected functionality and to time their behavior based on events within the program they accompany. Metadata for TDOs can be received in various ways (for example, via broadcast stream or the Internet). The receiver routes metadata to an active TDO.

Metadata and triggers drive TDO behavior in whatever way the author of the TDO intended. For example, metadata within a trigger can specify whether or not there is any available real estate on a screen at the current time, can cause a TDO to sleep or quit, and can initiate any desired action (including a change in appearance).

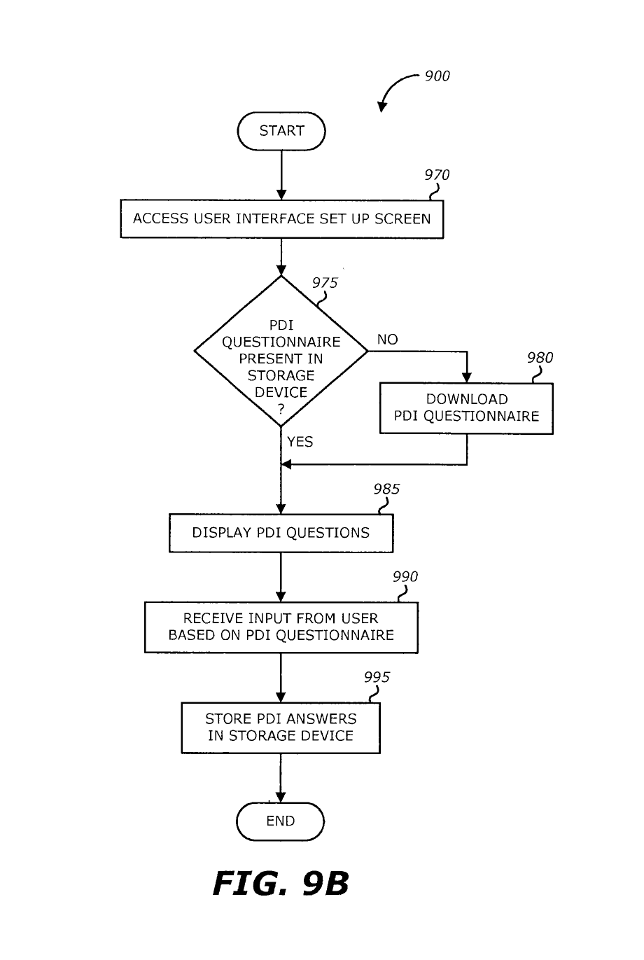

FIG. 9A is a diagram illustrating one embodiment directed to the registration of questions within a PDI questionnaire. Herein, according to one embodiment of the invention, a service provider 900 transmits a question inquiry request 910 to a registration entity 920. The “registration entity” may be a governmental agency, a third-party entity (e.g., Advanced Television Systems Committee “ATSC” or other standards body, bank or trusted institution, etc.) or any entity assigned the responsibility of receiving questions that are to be used for a PDI questionnaire and assigning question identifiers for each of these questions.

Question inquiry request 910 is information that identifies a proposed question for registration and subsequent inclusion in the PDI questionnaire downloaded to (or stored by manufacturer within) the receiver. As an example, question inquiry request 910 comprises (i) information 920 that identifies a reply format to the question (e.g., Boolean, integer type, single/multiple selection, variable text, etc.), and (ii) the proposed question 930. The transmission may occur during manufacture of the receiver, during a field upgrade of the receiver, during maintenance of a receiver, or the like.

In response to question inquiry request 910, service provider 900 receives a returned response 940 that identifies whether the question inquiry request 910 has been granted or denied. In particular, upon granting the request, response 940 includes (i) information 950 to identify whether the request has been granted, and (ii) a question identifier 955 that uniquely identifies the registered question. For instance, question identifier 955 may include a registration number for question 930. Upon denying the request, response 940 includes (i) information 960 to identify whether the request has been denied, and (ii) information 965 to identify the reason(s) for the denial. For instance, information 965 may be a code value that indicates that the question has already been registered, and perhaps the unique question identifier may be provided. Alternatively, information 965 may be a code value that indicates that the question contains inappropriate language or subject matter and is denied registration for this reason.

Referring now to FIG. 9B, a diagrams illustrating one embodiment of a system and method for receiving a PDI questionnaire and manipulating answers to the PDI questionnaire at a receiver is shown. According to this embodiment of the invention, the method for receiving a PDI questionnaire and manipulating answers to the PDI questionnaire at the receiver is shown. Herein, at block 970, a user accesses a set-up or preference screen with a receiver. The receiver determines whether a PDI questionnaire is available at block 975. If the receiver does not currently have a PDI questionnaire in storage, the receiver downloads at least one PDI questionnaire at block 980.

At block 985, PDI questions from the PDI questionnaire are displayed to the user. At block 990, the user inputs answers in response to the PDI questions. At block 995, the PDI answers are stored in a storage device of the receiver.

FIG. 10 is an illustration of an example of a data structure in XML format for representation of PDI questions. As illustrated in FIG. 10, standardization of preferences, demographics, and interests (PDIs) involve definition of a standard format for a downloadable questionnaire. The format of the questionnaire may include, but are not limited or restricted to question type identifier 1002, question identifier 1004, question 1006, and candidate answer(s) 1008 for the question.

Question type identifier 1002 identifies possible reply formats such as yes/no or true/false (QBA—Question Boolean Answer), text string (with maximum length) (QTA—Question Text Answer), multiple choice (QSA—Question Selection Answer), integer (with range limits) (QIA—Question Integer Answer), checklist, etc. Moreover, each question type identifier may further include an optional lifetime parameter to denote a lifetime of the answer to the question (or perhaps the question itself). For instance, as shown in FIG. 10, QIA 1010 concerning the oldest member of the household includes a lifetime attribute 1020 that may be used to identify the number of time units (e.g., minutes, hours, days, weeks, months, years, etc.) before the applicability of the answer expires. Of course, lifetime attribute 1020 alternatively may be used to identify the duration of the question. Upon expiration of the question, the PDI questionnaire may be updated to seek alternative questions for use in subsequent filtering of content.

The checklist reply format allows a user to provide a yes/no response to a number of different small items. For example, the query string might be “Which of the following sports do you follow?” The checklist might include football, basketball, soccer, rugby, hockey and baseball. Each of the items in the checklist may be selected or not selected. As previously discussed, access by receiver applications and TDOs to the PDI answers are made available via an API.

Question identifier 1004 allows the receiver to identify the question. For example, a question common to all service provider may be the zip code of the user of the receiver. Furthermore, question identifier 1004 allows a question to be associated with a particular service provider. For example, a service provider such as a sport channel, may be interested in asking a pertinent sport related question to the user, such as the user's favorite sport team. As such, question identifier 1004 allows the service provider to uniquely identify and associate the question with one or more service provider.

Question element “q” 1006 includes the actual question (e.g. “are you currently employed?”).

Candidate answers 1008 associated with question 1006 are listed. For instance, a multiple choice reply format would allow the user to select from among a fixed number of identified choices. As an example, a query string could be “In which of the following sports are you most interested?” The corresponding multiple choice answer might include the possibilities “Baseball,” “Basketball,” “Soccer,” and “Hockey.”

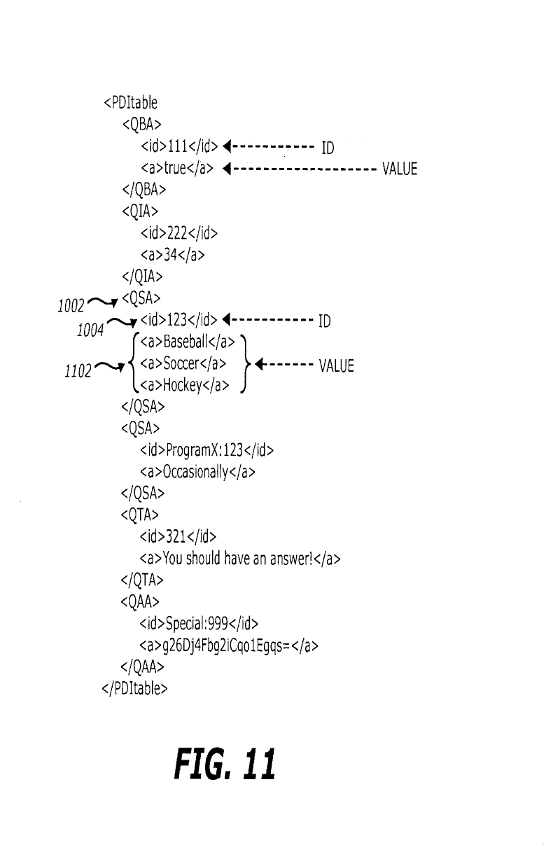

FIG. 11 is an illustration of an example of a data structure in XML format for PDI answers. The format of the answers might consist of question type identifier 1002, question identifier 1004, and an answer value 1102. Answer value 1102 includes the items selected by the user at the receiver.

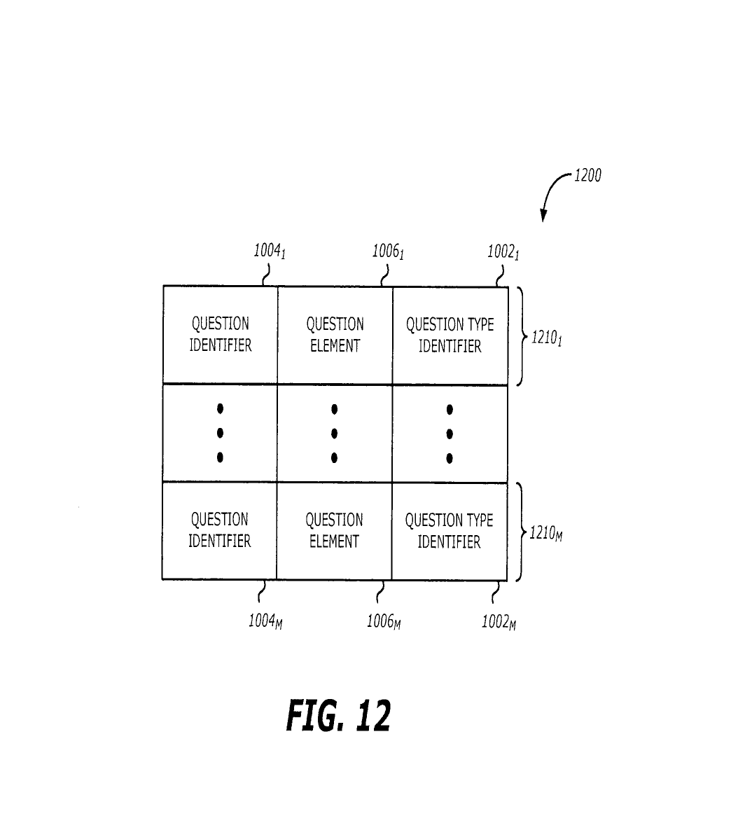

FIG. 12 is a block diagram illustrating one embodiment of a structure of a PDI container 1200. Generated and manipulated through an API implemented on the receiver, PDI container 1200 comprises a plurality of PDI data structures 1210₁-1210_{M} (M≧2). More specifically, according to this embodiment of the invention, each PDI data structure 1210_{M} includes defined syntax, representation and matching schema utilized by one or more service providers. For instance, PDI data structure 1210_{M} comprises a question identifier value 1004 that is used to identify the particular question registered with registration entity 920 of FIG. 9A. It is further contemplated that PDI data structure 1210_{M} may further comprise at least q-element 1006_{M} that identifies the question per se, and question type identifier 1002_{M} that identifies possible reply formats such as Boolean answers (QBA), text string (QTA), multiple choice (QSA), integer (QIA), checklist, etc.

It is contemplated that the contents of PDI data structures 1210₁-1210_{M} may be searchable for registration and confirmation whether questions proposed by a service provider have already been registered, and in such case, information associated with the registered question is returned to the service provider.

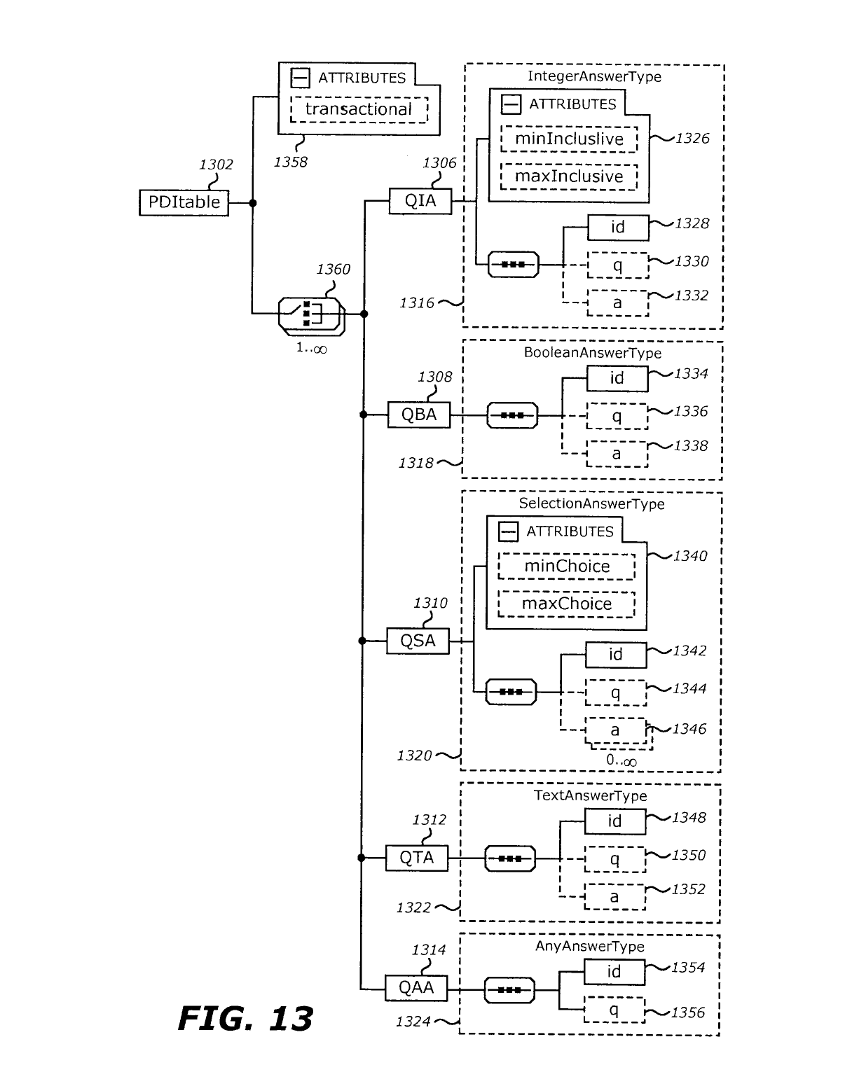

FIG. 13 is a block diagram illustrating one embodiment of a PDI table schema 1302 of a PDI container. The table schema 1302 includes a table attribute 1358 associated with several answer types 1360. For example, the answer types 1360 include one or more of a selection of answer types 1306, 1308, 1310, 1312, and 1314. For example, QIA 1306 refers to integer answer type 1316, QBA 1308 refers to Boolean answer type 1318, QSA 1310 refers to selection answer type 1320, QTA 1312 refers to text answer type 1322, and QAA 1314 refers to any answer type 1324.

In one embodiment, each answer type includes a question identifier (1328, 1334, 1342, 1348, and 1354), a question or inquiry (1330, 1336, 1344, 1350, and 1356) associated with the question identifier, and an answer (1332, 1338, 1346, and 1352) associated with the question identifier.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “forming” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. (canceled)

2. A receiving device comprising:
a tuner configured to receive a modulated input signal;
a demodulator configured to demodulate the input signal to produce an output stream;
a demultiplexer configured to demultiplex the stream to produce content data;
a processor configured to receive user-entered preference information;
storage configured to store the preference information, the preference information including at least one preference value associated with identification information and a preference type, wherein
the processor controls output of the content data to the user in accordance with the stored preference information.

3. The receiving device of claim 2, wherein the receiver is configured to capture, match, or filter the content data based on the stored preference information.

4. The receiving device of claim 2, wherein the processor controls the output of the content data using an Application Programming Interface (API) to access the stored preference information and control the output of the content data based on the accessed preference information.

5. The receiving device of claim 2, wherein the preference information further includes expiration information indicating an expiration time or expiration date for at least one preference value included in the preference information.

6. The receiving device of claim 2, wherein the preference information, including a prompt used to request the user to enter the preference information and a list of preference options associated with the prompt, are registered with a remote entity different from a provider of the content data.

7. The receiving device of claim 2, wherein
the stored preference information includes a default value when the user-entered preference information is not received by the processor,
the processor presents a prompt to the user to request the user to enter the preference information, the prompt including an ordered list of preference options, and
the stored preference information includes at least one channel associated with each preference value.

8. A receiving method comprising:
receiving a modulated input signal;
demodulating the input signal to produce an output stream;
demultiplexing the stream to produce content data;
receiving user-entered preference information;
storing the preference information, the preference information including at least one preference value associated with identification information and a preference type; and
controlling output of the content data to the user in accordance with the stored preference information.

9. The receiving method of claim 8, wherein the controlling includes capturing, matching, or filtering the content data based on the stored preference information.

10. The receiving method of claim 8, wherein the controlling includes using an Application Programming Interface (API) to access the stored preference information and controlling the output of the content data based on the accessed preference information.

11. The receiving method of claim 8, wherein the preference information further includes expiration information indicating an expiration time or expiration date for at least one preference value included in the preference information.

12. The receiving method of claim 8, wherein the preference information, including a prompt used to request the user to enter the preference information and a list of preference options associated with the prompt, are registered with a remote entity different from a provider of the content data.

13. The receiving method of claim 8, wherein
the stored preference information includes a default value when the user-entered preference information is not received by the receiving,
the method further comprises presenting a prompt to the user to request the user to enter the preference information, the prompt including an ordered list of preference options, and
the stored preference information includes at least one channel associated with each preference value.

14. A transmitting device comprising:
a multiplexer configured to generate a multiplexed signal by multiplexing plural content data streams, at least one of the content data streams associated with preference information;
a transmitter configured to transmit the multiplexed signal to a receiving device, wherein
the receiving device is configured to control output of at least one of the plural content data streams associated with user-selected preference information stored in the receiving device.

15. The transmitting device of claim 14, wherein the at least one of the content data streams is associated with the preference information using an Application Programming Interface (API).

16. The transmitting device of claim 14, wherein the preference information, including a prompt used by the receiving device to request the user to enter the preference information and a list of preference options associated with the prompt, are registered with a remote entity different from a provider of the content data.

17. The transmitting device of claim 14, wherein
at least one of the content data streams is associated with a default preference value, which is output by the receiving device when the user-entered preference information is not stored in the receiving device, and
the preference information stored in the receiving device includes at least one channel associated with each preference value and the multiplexed signal includes at least one content data stream corresponding to the at least one channel associated with at least one preference value.

18. A transmitting method comprising:
generating a multiplexed signal by multiplexing plural content data streams, at least one of the content data streams associated with preference information;
transmitting the multiplexed signal to a receiving device, wherein
the receiving device is configured to control output of at least one of the plural content data streams associated with user-selected preference information stored in the receiving device.

19. The transmitting method of claim 18, wherein the at least one of the content data streams is associated with the preference information using an Application Programming Interface (API).

20. The transmitting method of claim 18, wherein the preference information, including a prompt used by the receiving device to request the user to enter the preference information and a list of preference options associated with the prompt, are registered with a remote entity different from a provider of the content data.

21. The transmitting method of claim 18, wherein
at least one of the content data streams is associated with a default preference value, which is output by the receiving device when the user-entered preference information is not stored in the receiving device, and
the preference information stored in the receiving device includes at least one channel associated with each preference value and the multiplexed signal includes at least one content data stream corresponding to the at least one channel associated with at least one preference value.
